(19) United States
(12) Patent Application Publication
(10) Pub. No.: US 2007/0150514 A1
(43) Pub. Date: Jun. 28, 2007

(54) Establishment and execution system for enterprise activity management systems

(75) Inventors: Jung-Hsiang Chen, Taipei (TW); Cheng-Szu Chen, Taipei (TW); Chang-Ching Yeh, Taipei (TW); Chien-Jung Chen, Taipei (TW); Cher Jung Chen, Taipei (TW); Sheng-Huei Huang, Taipei (TW); Po-Sheng Hu, Taipei (TW)

Correspondence Address: BACON & THOMAS, PLLC, 625 SLATERS LANE, FOURTH FLOOR, ALEXANDRIA, VA, 22314, US

(73) Assignee: Sagatek Co., Ltd., Taipei (TW)

(21) Appl. No.: 11/304,667

(22) Filed: Dec. 16, 2005

(51) Int. Cl. G06F 17/00

(52) U.S. Cl. 707/104.1

(57) ABSTRACT

The invented establishment and execution system for enterprise activity management system comprises an enterprise activity flow planning system and an enterprise activity flow execution system. The enterprise activity flow planning system comprises: an activity flow planning module to allow users to define flows of a plurality of enterprise activities; an organization management module to allow user to define organizational structure of enterprise; an authorization management module to allow user to define functional relations of particular members in connection with particular activities; a data entity management module to allow user to define data entities; an enterprise resource management module to allow user to define enterprise resources; and a user interface to allow user to retrieve data from said enterprise activity management module, said enterprise organization management module, said authorization management module, said data entity management module and said enterprise resource management module and to edit the data.

### FIELD OF THE INVENTION

The present invention relates to an establishment and execution system for enterprise activity management system, especially to a system allowing users to design flows of enterprise activities, to establish enterprise activity management systems and to execute the established enterprise activity management systems.

### BACKGROUND OF THE INVENTION

Nowadays, speed and flexibility seem to be values of the time. Every organization shall try its best to respond to the rapid changes in the environment in order to survive. The internal operations of the organization need real time adjustments all the times so to satisfy the ever changing requirements from the market. Operations methods and. rules of an enterprise shall be dynamic, so that the organization may act like a living object, since a “frozen” organization had few chances to survive in this era.

Using a computerized system to manage the activities of an enterprise seems to be an inevitable choice. In order to comply with the trends of the time, all kinds of system development tools were announced. These developing tools allow users to design and develop all kinds of application software. However, the conventional developing tools for enterprise resources management systems were designed according to traditional theories in the field of software development. Obviously these theories don't apply, when the systems to be developed are development tools.

Under the traditional practice of software development, application programs are developed following the steps of: requirement, system analysis and programming, in sequence. Nowadays all development tools are so well designed and equipped that results of system analysis may be closely matched with requirements from users. Results of system analysis are expressed in forms of graphics, specifications and even simulations, so that users may easily review these results. However, when the development enters into the stage of programming, products so generated are not perceptible to users. When there are differences between results of system analysis and results of programming, either users or system analyzers are hardly able to participate in the correction process.

A reason of this phenomenon was because system analyses and flow analyses are conducted based on theories in the field of management science but programmers design the programs according to theories in the field of software engineering. Software engineering is something hard to really understand for those who are not engineers. Processes in correcting errors in the developed software programs are so unique that instructions from system analyzer can not be easily and correctly implemented. Development of software is thus delayed.

Under the traditional method of software development, demands from users are understood and described by system analysts from the view point of the computer system, whereby programmers may develop the software based on such understanding and descriptions As a result, many prejudices that were buried in the mind of system analysts and programmers, i.e., the “reasonable flows” according to their beliefs, shall control design of the software. In the past days, these reasonable flows did help the industry to correct activity flows of many companies. However, as more and more users require all activity flows shall be designed from users' view point, these prejudices became mythology. A software system designed following the traditional methodology provides activity flows that users are mandated to follow. Users thus lose their control on the flows, becoming an obstacle in the total computerization of the whole enterprise organization.

Nevertheless, an enterprise organization shall from time to time adjust its organization and operational flows in order to meet the non-stopping changes of the society. The traditional approach in developing software systems was not able to meet such requirements. When there is a need to adjust the organization structure or to change the operational flows, the whole system shall be reviewed and necessary revisions are evaluated. Very often one change in the operational flow would require changes in a plurality of changes in related subsystems, data files and program modules. In executing such changes, omissions and conflicts between instructions or flows would happen. Such problems delay the progress of automation of the enterprise organization.

It is thus necessary to provide a novel establishment and execution system for enterprise activity management system that may simplify the flow planning steps of the automation of enterprise activities and the establishment of enterprise activity management systems, whereby the systems so established are easy to use and to alter and comply with the needs of the user.

It is also necessary to provide a new establishment and execution system for enterprise activity management system to enable user to establish and execute enterprise activity management systems in an autonomic manner.

It is also necessary to provide an establishment and execution system for enterprise activity management system whereby enterprise activity management systems may be easily altered or revised.

### OBJECTIVES OF THE INVENTION

The objective of this invention is to provide a novel establishment and execution system for enterprise activity management system, whereby users of the enterprise activity management system may easily plan their activity flow, establish and use their enterprise activity management system.

Another objective of this invention is to provide a new establishment and execution system for enterprise activity management system to enable user to establish and execute enterprise activity management systems in an autonomic manner.

Another objective of this invention is to provide an establishment and execution system for enterprise activity management system whereby enterprise activity management systems may be easily altered or revised.

### SUMMARY OF THE INVENTION

According to this invention, a novel establishment and execution system for enterprise activity management system is provided. The invented system enables users to easily plan their enterprise activity flows and to easily generate and use enterprise activity management systems. The invented establishment and execution system for enterprise activity management system comprises an enterprise activity flow planning system and an enterprise activity flow execution system. In them, the enterprise activity flow planning system comprises:

an activity flow planning module to allow users to define flows of a plurality of enterprise activities; wherein said activity flow planning module receives user's inputs of enterprise activity definition related information and establishes definition files of particular enterprise activities, in which necessary information relating to definitions of enterprise activities, such as title of activity, members connected, authorization of said members, enterprise resource files used and relations between or among activities, is included;

an organization management module to allow user to define organizational structure of enterprise; wherein said organization management module receives user's inputs of enterprise organization definition related information and establishes definition files of enterprise organization, in which necessary information relating to definitions of enterprise organizations, such as structure of enterprise organization, members of particular organization, personal information, position and roles of such members and relations between or among said members, is included;

an authorization management module to allow user to define functional relations of particular members in connection with particular activities; wherein said authorization management module receives user's inputs of authorization definition related information and establishes authority definition files;

a data entity management module to allow user to define data entities; wherein said data entity management module receives user's inputs of data entity definition related information and establishes data entity definition files to include information such as file name, attribute, format and contents of data entities;

an enterprise resource management module to allow user to define enterprise resources; wherein said enterprise resource management module provides a plurality of templates, receives user's inputs of enterprise resource definition related information and establishes enterprise resource definition files to include announcements of resource nodes, contents of resources and included relations between or among resources; and

a user interface to allow user to retrieve data relating to said enterprise activity management module, said enterprise organization management module, said authorization management module, said data entity management module and said enterprise resource management module and to edit, including deleting, adding and modifications of, information relating to said modules.

Said enterprise activity flow execution system then comprises:

an execution engine, comprising a plurality of program elements to execute flows of particular enterprise activities according to definitions of said activities including members connected to said activities, authorizations of said members and relations between or among activities, upon excitement of said elements;

a program database to store definition files generated by said enterprise activity flow planning system and to define relations between particular definition files and elements contained in said execution engine; and

an output device to output results of execution of particular enterprise activity and to record said results.

These and other objectives and advantages of this invention may be clearly understood from the detailed description by referring to the following drawings.

### BRIEF DESCRIPTION OF THE DRAWINGS

FIG. 1 illustrates the outlines of the establishment and execution system for enterprise activity management systems of this invention.

FIG. 2 illustrates the systematic diagram of the establishment and execution system for enterprise activity management systems of this invention.

FIG. 3 illustrates the system structure of the enterprise activity flow planning module 1 of this invention.

FIG. 4 shows the flowchart of an enterprise activity management system generated by the systematic diagram of the establishment and execution system for enterprise activity management systems of this invention.

FIG. 5 shows an example of report input interface applicable in the enterprise activity management system of this invention

### DETAILED DESCRIPTION OF THE INVENTION

### I. The System

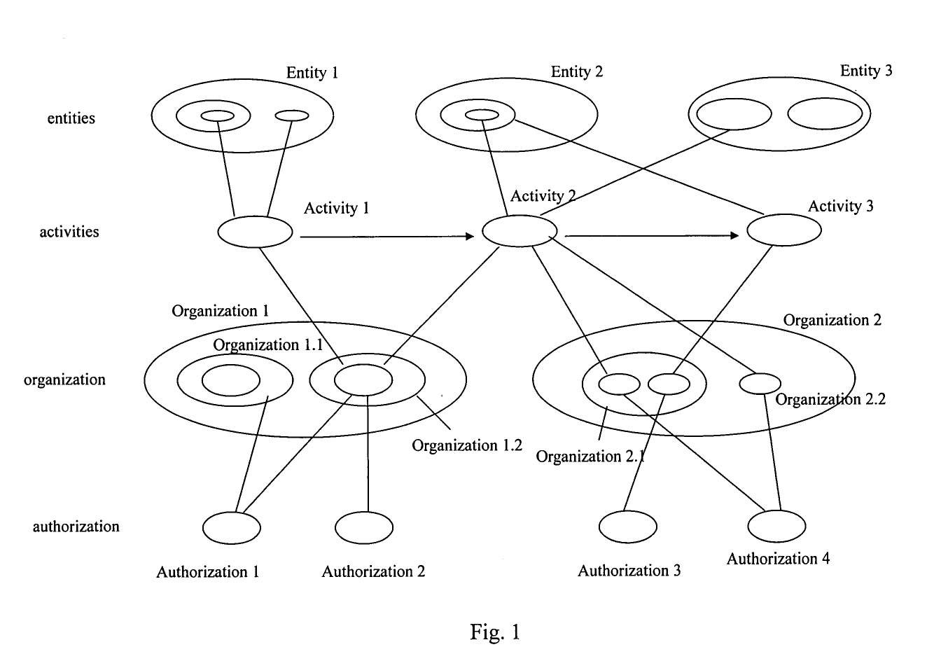

FIG. 1 illustrates the outlines of the establishment and execution system for enterprise activity management systems of this invention. This figure shows one design of the systematic diagram of the establishment and execution system for enterprise activity management systems of this invention. Of course, this figure is not any limitation to the scope of the present invention.

As shown in FIG. 1, the systematic diagram of the establishment and execution system for enterprise activity management systems of this invention allows users to design all kinds of application programs relating to possible enterprise activities, their flows and formats of data that may be generated. As a result, definition of an enterprise activity would include: title of the activity, members to be connected by the activity, authorizations of the members and enterprise resource files to be used in the activity. In addition, an enterprise activity may further involve other activities. In other words, the sequential relation between one activity and another may be included in a definition. In the embodiment of this invention, a particular enterprise activity is defined by an activity definition file to include the above-mentioned information.

Here, the term “enterprise activity” is used to include the enterprise resource files that may be operated by organizations of an enterprise, their access and edition and other operations. The term “operation” here used shall include retrieve, display, adding, deletion, modification, restore and transmission of enterprise resources. The term “enterprise organization” then means all related organizations within an enterprise, including any individual, internal unit and organization, external unit and organization, and any other individual or group that may access to the enterprise resources.

The term “enterprise” as used here is not limited to the concept of “company”. It shall include any group, company, organization or individual that uses the computer system to manage enterprises resources files. As a result, it may also mean a private enterprise, a foundation, a governmental branch, a military institute, an international organization etc.

The term “enterprise resource file” used herein shall mean all kinds of files that may be managed by the computer system, including all kinds of data, computer program, rules, records, inference etc., without being limited to any particular format.

In the present invention, the enterprise resource files are managed by an enterprise resource entity management module 15. Generally speaking, it is possible to use a large scale database system to manage a large quantity of enterprise resources. Each data file is classified, with its connections with other files being defined. The definitions are stored in a data management module 14, wherein particular enterprise resource files are defined as data entities. In FIG. 1, 3 data entities are shown. They are Entity 1, Entity 2 and Entity 3.

All members of the enterprise are positioned in an enterprise structure. In application, a hierarchic structure may be established to manage such members. In other words, each member is connected to one or more levels in the enterprise organizational structure. The hierarchic structure is used to define relations between or among members. They may be in a parallel relation or vertical relation; a direct relation or indirect relation etc. Relations between or among members are used as reference in defining particular activities. In FIG. 1, circles are used to represent sub-organizations, or called “unit”, in an enterprise organization. The figure shows that an unit may include units inside it. All members belong to particular units.

The relation between one member and one activity is called “authorization”. Here, the term “authorization” indicates method of use of particular data entities allowed to the member in the activity. Such methods include: retrieve, reading, adding, deletion, modification, approval, restore, transmission etc. In FIG. 1, 4 kinds of authorizations are shown. The authorization given to a member in one activity may be different from that in another activity.

By doing so, an activity is defined by its connection to particular “members” of particular “organization”, “authorization” of the members and its connection to particular “data entities”. As a result, an activity is defined by defining its title, defining members and organizations that it should connect, defining authorizations of the members and defining data entities that it should connect. In addition, an activity may have sequential relation with others. It may be necessary to define sequential relations of the activity, when definitions of the activity are given. The sequential relation may be reversible or irreversible.

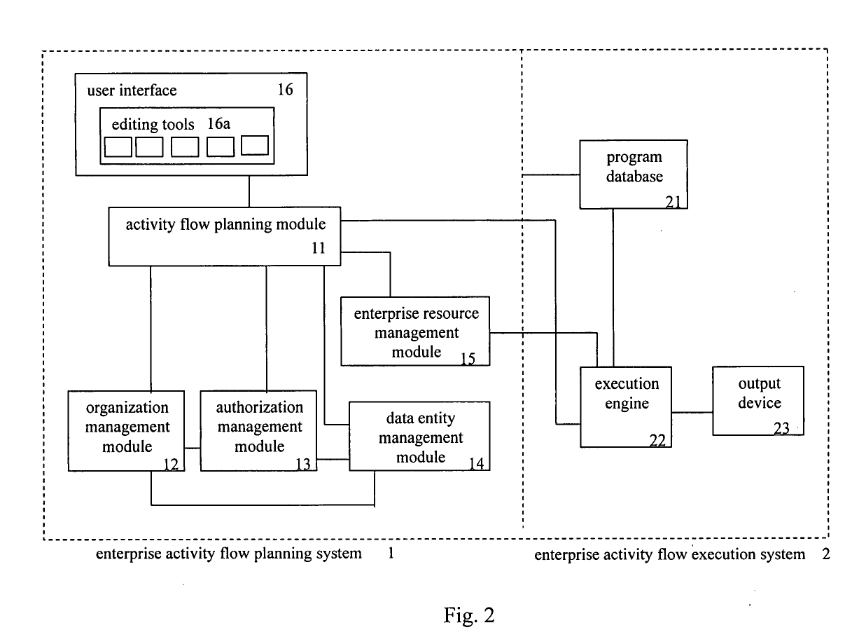

FIG. 2 illustrates the systematic diagram of the systematic diagram of the establishment and execution system for enterprise activity management systems of this invention. As shown in this figure, the systematic diagram of the establishment and execution system for enterprise activity management systems of this invention comprises an enterprise activity flow planning system 1 and an enterprise activity flow execution system 2. The enterprise activity flow planning system 1 comprises:

an activity flow planning module 11 to allow users to define flows of a plurality of enterprise activities;

an organization management module 12 to allow user to define organizational structure of enterprise;

an authorization management module 13 to allow user to define functional relations of particular members in connection with particular activities;

a data entity management module 14 to allow user to define data entities;

an enterprise resource management module 15 to allow user to define enterprise resources; and

a user interface 16 to allow user to retrieve data relating to said enterprise activity management module, said enterprise organization management module, said authorization management module, said data entity management module and said enterprise resource management module and to edit, including deleting, adding and modifications of, information relating to said modules.

In the above-mentioned modules, the activity flow planning module 11 receives user's inputs of enterprise activity definition related information and establishes definition files of particular enterprise activities, in which necessary information relating to definitions of enterprise activities, such as title of activity, members connected, authorization of said members, enterprise resource files used and relations between or among activities, is included.

The organization management module 12 receives user's inputs of enterprise organization definition related information and establishes definition files of enterprise organization, in which necessary information relating to definitions of enterprise organizations, such as structure of enterprise organization, members of particular organization, personal information, position and roles of such members and relations between or among said members, is included;

The authorization management module 13 receives user's inputs of authorization definition related information and establishes authority definition files;

The data entity management module 14 receives user's inputs of data entity definition related information and establishes data entity definition files to include information such as file name, attribute, format and contents of data entities;

The enterprise resource management module 15 provides a plurality of templates, receives user's inputs of enterprise resource definition related information and establishes enterprise resource definition files to include announcements of resource nodes, contents of resources and included relations between or among resources; and

Also as shown in FIG. 2, the enterprise activity flow execution system then comprises:

an execution engine 22, comprising a plurality of program elements to execute flows of particular enterprise activities according to definitions of said activities including members connected to said activities, authorizations of said members and relations between or among activities, upon excitement of said elements;

a program database 21 to store definition files generated by said enterprise activity flow planning system and to define relations between particular definition files and elements contained in said execution engine; and

an output device 23 to output results of execution of particular enterprise activity and to record said results.

Also as shown in FIG. 2, an editing tool 16a is provided in the user interface 16 of the enterprise activity flow planning module 1. The editing tool 16a allows user to design activity flows in the user interface 16. The editing tool 16 provides functions such as: flow design, activity design, entity design, organization design and report design etc.

### II. The Enterprise Activity Flow Planning System 1

Although it is not intended to limit this invention to any particular theory, it has been found that in the present invention, the concept of “enterprise resource management orientation” methodology is used to design the systematic diagram of the establishment and execution system for enterprise activity management systems of this invention. Such methodology is rather different from the known “object orientation” methodology or “process orientation” methodology in the conventional art. Under the resource orientation methodology, all related elements in the enterprise knowledge system, including processes and data, are classified into all kinds of enterprise resources, such as the above-mentioned activity, flow, organization, authorization, data entity, report etc., and are managed in an integrated manner. Following this methodology, enterprise activity management systems so designed are simply used to manage all kinds of enterprise resources. As a result, method for developing an enterprise activity management system may be simplified into steps of defining and connecting enterprise resources. When such definitions and connections are complete, the software system is complete.

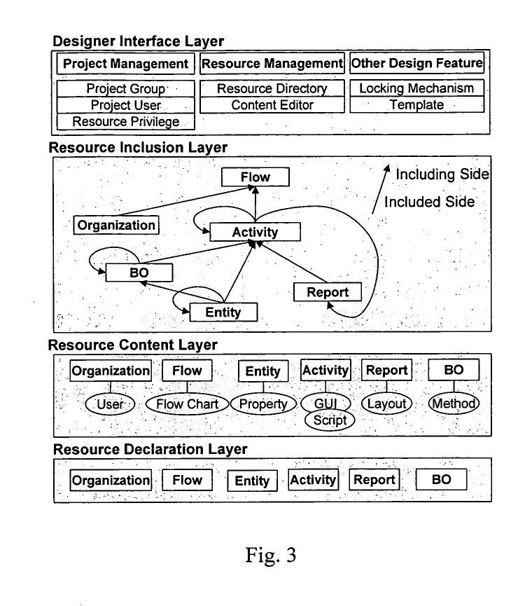

In the developing tools that are provided to users by the systematic diagram of the establishment and execution system for enterprise activity management systems of this invention, molds of enterprise resources are described in a layered structure. FIG. 3 illustrates the system structure of the enterprise activity flow planning module 1 of this invention. As shown in this figure, the enterprise activity flow planning module 1 has a layered structure, such that only necessary layers of the enterprise resources may be accessed when the resource molds are established, managed and reviewed. Such structure prevents unnecessary introduction of information during the process. In the embodiment of this invention, the layered structure is divided into 4 layers. They are: announcement of resource node, definition of content, inclusion of resource and design interface. Detailed description will be given below:

Announcement of Resource Nodes

In this layer, the enterprise activity flow planning module 1 divides management activities of enterprise resources into classes and provides a development tool for enterprise activity management systems, so that users may announce several resource nodes using contents of enterprise activity to be planed according to actual needs of the enterprise.

Under the enterprise resource management orientation methodology, all content relating to daily operation of an enterprise may all be seen as resources. They may include: enterprise organization, enterprise activity, activity flow, data entity, asset, report, filing of documents, information system, project etc. However, in the embodiment of this invention, having considered convenience in developing systems, only a limited number of kinds of enterprise resources is provided. More specifically, 6 kinds of resources are provided to cover almost all necessary resources. These types of resource are: organization, activity flow, data entity, activity, report and business object. Of course, it is possible to provide less or more types of enterprise resources, depending on the actual needs of the related enterprise.

Definition of Resources

In this layer, the enterprise activity flow planning module 1 of this invention provides a tool to allow user to describe particular contents of resource nodes to be defined, so that particular resources may be expressly defined. Descriptions of each type of resource may contain the following items:

Organization: Defined by its member, structure diagram, roles and role relations of members etc.

Flow: Defined by flowchart, information of operator etc.

Data entity: Defined by type, attributes, data format etc.

Activity: Defined by interactive graphic user interface, description of content etc.

Report: Defined by report layout, source of data etc.

Business objects: defined by description of content of business logics etc.

Resource Inclusion

Under the methodology of enterprise resource management, relations between or among resource nodes are called “included relation”. In this layer, the enterprise activity flow planning module 1 of this invention provides a development tool to allow user to define connections between particular resource nodes with another. Such definitions are used as descriptions to enterprise knowledge. All resource nodes may operate the behavior of its called nodes or identify attributes of the included nodes, according to given inference rules, when the including notes are executed.

Design Interface

The enterprise activity flow planning module 1 of this invention establishes an operational environment for developing systems, allowing user to plan and to design all kinds of enterprise activity management systems through the provided simple and easy operational interface 16. In addition to providing design environments for the above-mentioned 3 layers (resource node announcement, resource content definition and resource inclusion), this layer provides further functions to facilitate design and establishment of software systems. As shown in FIG. 3, the design interface of this invention provides design tools such as plan management tools, resource management tools and other design functions. All these functions are provided so that user may use the design interface to announce resource nodes, define contents of resources, defined included relations of resources, when an enterprise activity management system is designed.

In the enterprise activity flow planning module 1 of this invention, the layered structure is provided in the enterprise activity flow management module 11, the enterprise organization management module 12, the data entity management module 14 and the enterprise resource management module 15. The system is thus made simplified and user's planning and design of enterprise activity management system are made easier.

In application, the user interface 16 may display each resource in related resource directory or directories. Each type of resource is provided one content editor so that a uniformed operation concept is given to resources of the same type. User may first identify position of a resource in the directory and call out content editor corresponding to the resource. Contents of the resource are set and relations of resources are established by using the content editor. In designing the interface, each type of resource may be managed by particular resource directory, using a tree filing structure. It is possible to provide a variety of content editors for one type of resource, according to features of the resource. Also, functions such as maintenance of relations between or among resources may be provided in the content editor.

The enterprise activity flow management module 11 is used to manage flows of all kinds of enterprise activities. In the present invention, resources to be used in an enterprise activity are connected by its flows. Resources to be connected to an enterprise activity include roles of activity and execution of activity. Definition of a flow describes structure of the flow and connections between activity and flows. In the embodiment of this invention, 4 major flow elements are used in the enterprise activity flow management module 11 to describe structure and behaviors of flows: activity dispatch method (ADM), condition dispatch method (CDM), jump dispatch method (JDM) and parallel dispatch method (PDM). These elements enable description of all kinds of flows and easy alternations of the flows. In these elements, advanced functions such as automatic flow trigger function, subroutine trigger function, multiple party review function, dynamic execution role definition function, dynamic subroutine trigger setting function, parallel flow setting function, processing time setting function and flow display function etc.
ADM: Activity dispatch element to set roles of operation and corresponding enterprise activities of a flow. Time limit of processing may be set using this element.
CDM: Condition dispatch element to change direction of a flow. Direction of a flow may be altered according to actual situation by altering situation code of particular elements.
JDM: Jump dispatch element to change direction of a flow. It differs from CDM in that JDM changes the direction in a jumping manner.
PDM: Parallel dispatch element, a container element to include other subroutines.

According to the operation of each enterprise activity, the enterprise activity flow planning module 11 helps establishing an interactive user interface and to establish the interactive relations among enterprise activities and data entities and business objects in the enterprise activity flow planning module 11.

In order to provide an interactive user interface, several basic interactive elements are provided in the enterprise activity flow planning module 11, such as label, edit box, image, text area, container control grid etc. In the enterprise activity flow planning module 11, several advanced functions may also be provided, such as popup activity, included activity etc. Other functions may be provided to strengthen the functionality of the system.

The enterprise organization management module 12 establishes the relation between organization and roles according to the structure of the organization and job descriptions of its members. When the organizational structure and the roles are defined, relations between members and the organization may be established through definitions of the roles. In this invention, one member may have more than one role. For example, an R/D engineer may at the same time act as technician of the customer service department. Such design enables the system so developed complying more closely to the actual operation of the enterprise. By setting the roles of particular members, the members would have a variety of operational functions. In addition to setting of organization and roles, the enterprise organization management module 12 may also provide the function of setting department leader and deputies.

The authorization management module 13 provides the function of allowing user to define functional relation of particular members and particular activities. In all enterprise activity management systems, it is always the most important security concern to determine authorizations of a member in participating in particular enterprise activities, i.e., in using particular enterprise resources. The authorization management module 13 provides a tool to allow user to input definition related information of particular members' access to particular enterprise resources, so to ensure information security. Modifications to authorization may be made in a similar way.

The data entity management module 14 provides the function of establishment and management of data entities. A “data entity” is generally used to represent data belonging to a same type. The concept of data entity satisfies the concept of data model analysis. Operational logics of data are combined in the concept of data entity so that data entities may express their meanings in the process of analysis. All resources of this system process data entities through the data entity management module 14.

The enterprise resource management module 15 processes business logics and behavior definitions contained in the activity flows. In the embodiment of this invention, all business logics of activities are described by business objects. A business object represents one particular logic behavior. A next logic behavior may be inferred when a business object includes another. The business logics of an enterprise are embedded into business objects. Processing of enterprise activities and business objects shall go through data entities layer by layer. When a business object is defined, it may be called by the enterprise activity flow planning module 11. These business objects are expressed by functions of the enterprise activity flow planning module 11.

### III. The Enterprise Activity Flow Execution System 2

As described above, the enterprise activity flow execution system 2 comprises a program database 21 to store definition files generated by the enterprise activity flow planning system 1 and to establish relations between all definition files and corresponding elements in the execution engine 22. In the embodiment of this invention, the program database 21 provides related key technologies to make applications of the enterprise activity management system easier and safer. These tools include: a resource editing module, a name system and a resource relation chart.

Resource Editing Module

In the present invention, molds of resources are divided into 3 layers, according to depth and function orientations of the resource molds. They are preservation layer, management layer and edition layer. Through the interoperation o the 3 layers, each resource may maintain a uniformed concept and operation method.

The preservation layer: Preserves all definition files of resources.

The management layer: Provides directory structure and manages addresses of resources. It helps review of resources in the system and classification and reduction of resources.

The edition layer: Provides edition of content of resources and establishes relations between resources.

Name System

In this invention, each resource has a sole name or title.

Resource Relation Chart (RRC)

In the invented system, the relation between resources is established by including to each other. When such relation is established, resources with included relation may behave interactively. Under such relation, the included resource is called “child”. The two resources form a parent-child relation. Through such relation, analysis and maintenance of system are made easier.

The functions of the resource relation chart include to maintain and to manage relations between resources and to define relations between the including resources and the included resources. Through such measurement, system designers may easily perceive inclusion relations among resources and how they influence one another.

Enterprise activity management systems so developed are stored in the program database 21. Each program contains a series of definitions of activity. Descriptions of the definitions include announcement, definitions and inclusion relations of enterprise resources, and their interfaces. Such type of program files may be called “meta data”, since they are perceptible to ordinary persons, not just descriptions that only professional programmers could understand.

In the execution engine 22 a plurality of program elements is included. The included elements may be called by the enterprise activity management system, whereby flows defined in the activity may be executed in connection with connected members, organizations, authorities, resource files and relations between activities. Once a program element is verified and approved, it is stored in the execution engine 22 for execution. When any content of activity, connected member, authorization or other parameters need to be adjusted, the only labor is to call out related programs from the program database 21, display them in the user interface 16 and modify the contents. Process in modifying the program is exactly the same as in planning. No program element in the execution engine 22 would be influenced. In addition, as the programs are described as meta data, results of modification would satisfy all purposes and expectations of the modification request. Gap among user, system analyzer and programmer is thus eliminated.

After execution of the program, the results may be output by the output device 23. The results would be recorded as well. The output device 23 may be a screen display, a printer, an audio generator, or any other output media.

### IV. Embodiments

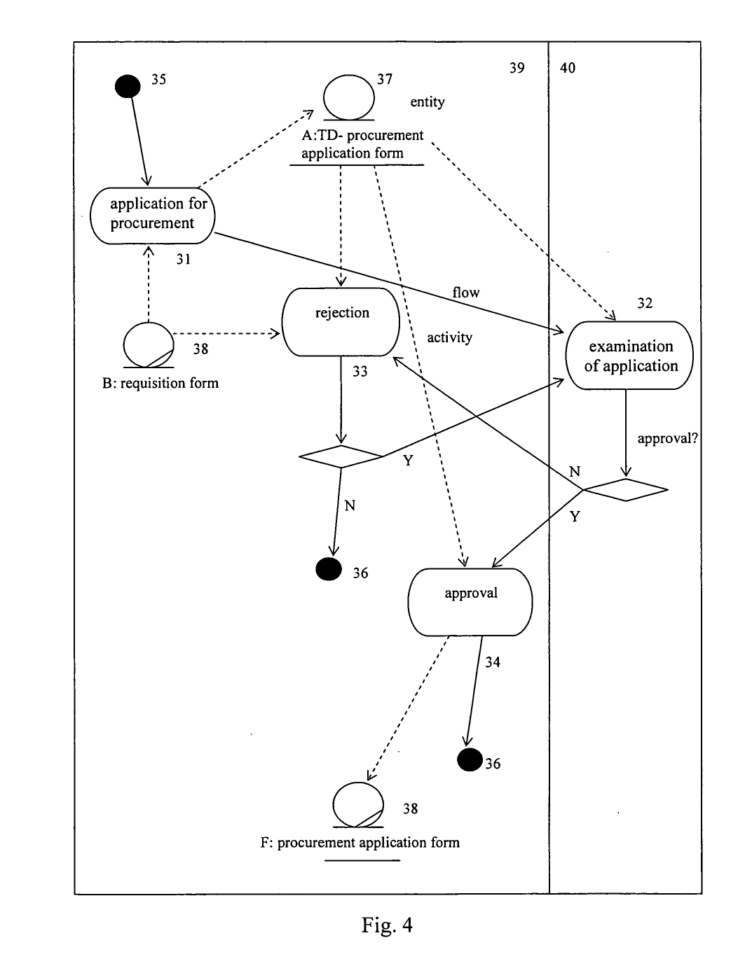

FIG. 4 shows the flowchart of an enterprise activity management system generated by the systematic diagram of the establishment and execution system for enterprise activity management systems of this invention. As shown in this figure, the enterprise activity relates a procurement request procedure. In the figure, orbits represent enterprise activities, including application for procurement 31, examination of application 32, rejection 33 and approval 34. Arrowed lines represent sequences of flows. Dark circles represent status of activity, including initial status 35 and final status 36. Blank circles represent data entities. In this example, only one data entity is shown, the application form data generator file 37. A procurement record, not shown, would be generated after this activity is complete. Grid circles are reports. In this example the report is a procurement application form 38. In addition, diamond shapes represent decisions. Areas divided by lines are organizations, including applicant's department 39 and information department 40.

When a user uses the edition tool provided in the user interface 16 of the enterprise activity management systems, the user may cal out all kinds of icons representing organization, activity, authorization and data entity. The user may further use the edition tool to define content of all these icons and their relations to form a network. The finished network represents an enterprise activity. The enterprise activity so defined is then stored in the program database 21 in the form of meta data. A program is thus developed. The program may be called to execute. Modifications of the program may follow the same procedure. Problems existed in the conventional art may thus be avoided.

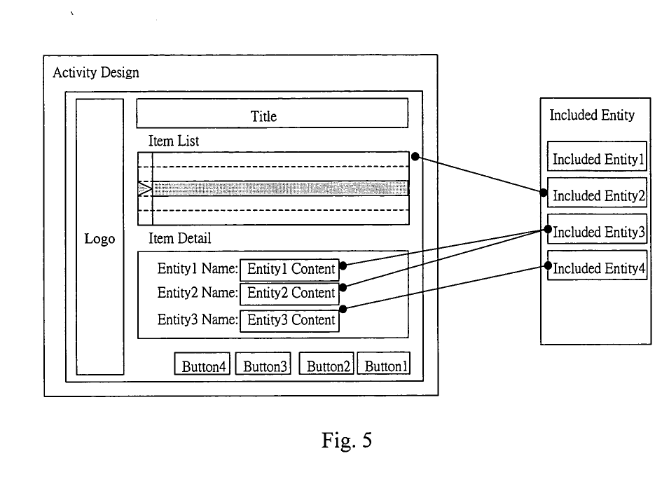

In the present invention, design of reports is also an index to determine whether the flows of an enterprise activity are property. FIG. 5 shows an example of report input interface applicable in the enterprise activity management system of this invention. In the figure, a form report, as well as content of data entities connected to the related enterprise activity, is shown. As shown in this figure, the enterprise activity management system of this invention treats definitions of a report as a data entity. Each report data entity may include necessary definitions and is connected to related organizations, members and activities. The report input interface enables simple and easy operation, whereby user may design a useful report within a very short time.

In the enterprise activity execution system 2 of this invention, the execution engine 22 grabs from the program database 21 flow descriptions generated by the enterprise activity flow planning system 1 and calls out related program elements to execute them in the defined sequence. Results of the execution are a series of enterprise activity.

As the present invention has been shown and described with reference to preferred embodiments thereof, those skilled in the art will recognize that the above and other changes may be made therein without departing form the spirit and scope of the invention.

What is claimed is:

1. An establishment system for enterprise activity management system, to be installed in a computer system to allow user to establish an enterprise activity management system and to execute said enterprise activity management system, comprising an enterprise activity flow planning system and an enterprise activity flow execution system; wherein said enterprise activity flow planning system comprises:
an activity flow planning module to allow users to define flows of a plurality of enterprise activities;
an organization management module to allow user to define organizational structure of enterprise;
an authorization management module to allow user to define functional relations of particular members in connection with particular activities;
a data entity management module to allow user to define data entities;
an enterprise resource management module to allow user to define enterprise resources; and
a user interface to allow user to retrieve data relating to said enterprise activity management module, said enterprise organization management module, said authorization management module, said data entity management module and said enterprise resource management module and to edit said data.

2. The establishment system for enterprise activity management system according to claim 1, wherein said activity flow planning module receives user's inputs of enterprise activity definition related information and establishes definition files of particular enterprise activities, in which necessary information relating to definitions of enterprise activities, including title of activity, members connected, authorization of said members, enterprise resource files used and relations between or among activities, is included.

3. The establishment system for enterprise activity management system according to claim 1, wherein said organization management module receives user's inputs of enterprise organization definition related information and establishes definition files of enterprise organization, in which necessary information relating to definitions of enterprise organizations, including structure of enterprise organization, members of particular organization, personal information, position and roles of such members and relations between or among said members, is included.

4. The establishment system for enterprise activity management system according to claim 1, wherein said authorization management module receives user's inputs of authorization definition related information and establishes authority definition files to include method of use of particular data entities, including retrieve, view, adding, deletion, modification, approval, restore and transmission.

5. The establishment system for enterprise activity management system according to claim 1, wherein said data entity management module receives user's inputs of data entity definition related information and establishes data entity definition files to include information such as file name, attribute, format and contents of data entities.

6. The establishment system for enterprise activity management system according to claim 1, wherein said enterprise resource management module provides a plurality of templates, receives user's inputs of enterprise resource definition related information and establishes enterprise resource definition files to include announcements of resource nodes, contents of resources and inclusion relations between or among resources.

7. The establishment system for enterprise activity management system according to claim 6, wherein definition of activity in said enterprise resource management module further includes sequential relation of said activity and other activities.

8. The establishment system for enterprise activity management system according to claim 1, wherein said enterprise activity flow planning system provides a layered structure to allow user to establish, manage and review said enterprise activity management system and other enterprise resources, said layered structure comprising from top to down an announcement of enterprise resource node layer, a content definition layer, an resource inclusion layer and a design interface layer.

9. The establishment system for enterprise activity management system according to claim 1, wherein said enterprise resource comprises information relating to organization of said enterprise, activity flow, data entity, enterprise activity, report and business object.

10. The establishment system for enterprise activity management system according to claim 1, wherein said enterprise activity flow planning system provides a layered structure to allow user to establish enterprise activity management systems; wherein said layered structure comprises:
a preservation layer to preserve definition files of resources;
a management layer to provide directory structure and manages addresses of resources; and
an edition layer to allow edition of content of resources and establishes relations between resources.

11. An establishment and execution system for enterprise activity management system, to be installed in a computer system to allow user to establish an enterprise activity management system and to execute said enterprise activity management system, comprising an enterprise activity flow planning system and an enterprise activity flow execution system; wherein said enterprise activity flow planning system comprises:
an activity flow planning module to allow users to define flows of a plurality of enterprise activities;
an organization management module to allow user to define organizational structure of enterprise;
an authorization management module to allow user to define functional relations of particular members in connection with particular activities;
a data entity management module to allow user to define data entities;
an enterprise resource management module to allow user to define enterprise resources; and
a user interface to allow user to retrieve data relating to said enterprise activity management module, said enterprise organization management module, said authorization management module, said data entity management module and said enterprise resource management module and to edit said data; and
wherein said enterprise activity flow execution system comprises:
an execution engine, comprising a plurality of program elements to execute flows of particular enterprise activities according to definitions of said activities upon excitement of said elements;
a program database to store definition files generated by said enterprise activity flow planning system and to define relations between particular definition files and elements contained in said execution engine; and
an output device to output results of execution of particular enterprise activity and to record said results.

12. The establishment and execution system for enterprise activity management system according to claim 1, wherein said activity flow planning module receives user's inputs of enterprise activity definition related information and establishes definition files of particular enterprise activities, in which necessary information relating to definitions of enterprise activities, including title of activity, members connected, authorization of said members, enterprise resource files used and relations between or among activities, is included.

13. The establishment and execution system for enterprise activity management system according to claim 1, wherein said organization management module receives user's inputs of enterprise organization definition related information and establishes definition files of enterprise organization, in which necessary information relating to definitions of enterprise organizations, including structure of enterprise organization, members of particular organization, personal information, position and roles of such members and relations between or among said members, is included.

14. The establishment and execution system for enterprise activity management system according to claim 1, wherein said authorization management module receives user's inputs of authorization definition related information and establishes authority definition files to include method of use of particular data entities, including retrieve, view, adding, deletion, modification, approval, restore and transmission.

15. The establishment and execution system for enterprise activity management system according to claim 1, wherein said data entity management module receives user's inputs of data entity definition related information and establishes data entity definition files to include information such as file name, attribute, format and contents of data entities.

16. The establishment and execution system for enterprise activity management system according to claim 1, wherein said enterprise resource management module provides a plurality of templates, receives user's inputs of enterprise resource definition related information and establishes enterprise resource definition files to include announcements of resource nodes, contents of resources and inclusion relations between or among resources.

17. The establishment and execution system for enterprise activity management system according to claim 6, wherein definition of activity in said enterprise resource management module further includes sequential relation of said activity and other activities.

18. The establishment and execution system for enterprise activity management system according to claim 1, wherein said enterprise activity flow planning system provides a layered structure to allow user to establish, manage and review said enterprise activity management system and other enterprise resources, said layered structure comprising from top to down an announcement of enterprise resource node layer, a content definition layer, an resource inclusion layer and a design interface layer.

19. The establishment and execution system for enterprise activity management system according to claim 1, wherein said enterprise resource comprises information relating to organization of said enterprise, activity flow, data entity, enterprise activity, report and business object.

20. The establishment and execution system for enterprise activity management system according to claim 1, wherein said enterprise activity flow planning system provides a layered structure to allow user to establish enterprise activity management systems; wherein said layered structure comprises:
a preservation layer to preserve definition files of resources;
a management layer to provide directory structure and manages addresses of resources; and
an edition layer to allow edition of content of resources and establishes relations between resources.
